(19) United States
(12) Patent Application Publication
(10) Pub. No.: US 2008/0193608 A1
(43) Pub. Date: Aug. 14, 2008

(54) Coating for adhering finely divided ingredients to bean, pea and nut substrates

(75) Inventor: Joseph A. Formanek, Bolingbrook, IL (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Griffith Laboratories International, Inc., Alsip, IL (US)

(21) Appl. No.: 11/706,602

(22) Filed: Feb. 13, 2007

(51) Int. Cl. A23L 1/36

(52) U.S. Cl. 426/93; 426/289; 426/296; 426/293; 426/292

(57) ABSTRACT

Unique adherent coated roasted and unroasted bean, pea and nut substrates carrying finely divided ingredients, the adherent coating including an alginate salt, a source of calcium ions and carrageenan, and the method of making such unique coated beans, peas and nuts.

### BACKGROUND OF THE INVENTION

This invention relates generally to compositions and methods for adhering fine particulates and powdered coatings to beans, peas and nuts and particularly, to coatings and methods for adhering powders under 80 mesh in cross-section and fine particulates that are between about 10 and 80 mesh in cross-section to bean, pea and nut substrates in such a way that the powdered coatings and particulates are substantially fully retained even when the coated substrate is subject to forces that would be expected to break off some of the particulate coating such as abrasion between adjacent coated beans, peas and nuts during shipment and handling, and crumbling of the coating that commonly occurs on cooling of the coated substrate.

In preparing roasted and unroasted beans, peas and nuts for eating it is often necessary or desirable to modify or improve the beans, peas and nuts by adhering fine particulate or powdered coatings. However, it is important that the coatings be retained even when the coated substrate is subjected to forces that would be expected to break off some of the coating or cause crumbling. Unfortunately, when in the past such fine materials were used to coat roasted and unroasted beans, peas and nuts, portions of the coatings tended to chip off or crumble, leaving an aesthetically undesirable product as well as an undesirable powdery residue that collected in containers or came off when the product was handled by the end user.

It is therefore an object of the present invention to provide compositions and methods for securely adhering such finely divided ingredients to roasted and unroasted beans, peas and nuts in such a way that the finely divided ingredients are retained even when the coated substrate is subjected to forces that would be expected to degrade the coatings.

It is a further object of the present invention to provide compositions and methods for adhering such finely divided ingredients to roasted and unroasted beans, peas and nuts without creating undesirable organoleptic properties at the surface of the substrates.

Yet another object of the invention is to provide compositions and methods for securely adhering such finely divided ingredients to roasted and unroasted beans, peas and nuts in a coating that does not obscure the color or other visual characteristics of the substrate.

These and other objects of the present invention will be apparent from the description that follows.

### SUMMARY OF THE INVENTION

The present invention comprises an adherent coating composition and a method for binding finely divided ingredients to roasted and unroasted beans, peas and nuts in such a way that the coatings are retained even when the coated substrate is subjected to forces that would be expected to break off coating portions or otherwise degrade the coatings. The adherent composition comprises a combination of an alginate salt, a source of calcium ions, and carrageenan.

The finely divided ingredients may be bound to the roasted and unroasted beans, peas and nuts by dispersing the finely divided ingredients in the adherent coating composition and then: a) applying a slurry of the mixture of adherent composition and finely divided ingredients to the substrate (e.g., by a tumbling application); or b) by wetting the beans, peas and nuts with water and then coating with a dry mixture of the finely divided ingredients and the adherent composition. Among these application techniques, the slurry application is preferred for finely divided ingredients in the form of fine particulates that are between about 10 and 80 mesh in cross-section and the dry application is preferred for powders under 80 mesh in cross-section. Also, if desired, multiple slurry or dry coatings may be applied and both slurry and dry coatings may be used with a single substrate. In the latter case it is preferred that the slurry application of fine particulates is followed by the dry powder application.

The present invention also includes a product comprising roasted and unroasted beans, peas and nuts with a set adherent coating composition on the substrate and finely divided ingredients embedded in or bound to the coating.

### DETAILED DESCRIPTION OF A PREFERRED EMBODIMENT

The adherent composition of the present invention produces a continuous coating on roasted and unroasted beans, peas and nuts that functions as a vehicle to adhere finely divided ingredients, including fine particulates that are between about 10 and 80 mesh in cross-section (and preferably between about 30 and 80 mesh) and powders under 80 mesh in cross-section so that the coating and finely divided ingredients are retained even when the coated substrate is subjected to forces that would be expected to degrade the coating. Particulates that may be used include: finely ground herbs (e.g., thyme, oregano and basil); black, white and red pepper; and vegetable flakes (e.g., parsley flakes). Powders that may be applied include vegetable powders (e.g., onion and garlic powder); salt; and, sugars. The finely divided ingredients typically will be supplied at a level that will substantially cover the entire exposed surface of the substrate.

An adherent composition/particulate combination in accordance with the present invention may be prepared by adding an appropriate desired level of finely divided ingredients to the adherent coating composition and mixing until the particulates are fully dispersed. The resulting composition then may be applied, for example, by forming an aqueous slurry of the mixture and applying it to the substrate. Alternatively, the mixture may be applied as a dry mixture to a pre-wetted substrate.

The adherent coating itself is substantially transparent or invisible in the sense that a person eating the coated substrate generally will not be able to tell that there is an adherent coating on it either visually or organoleptically (e.g., by way of tackiness or tooth pack when he bites down on the coated substrate). The adherent composition will comprise a source of alginate (preferably sodium alginate), a source of calcium ions and a gum. The level of alginate should be chosen to deliver about 0.001 to 0.1 percent by weight of alginate based on the weight of the roasted beans, peas and nuts. Preferably the level of alginate will be chosen to deliver about 0.01% percent by weight for dry powder applications to pre-wetted substrates and about 0.005% percent by weight for aqueous slurry applications. The level of alginate in the adherent composition will therefore depend on the substrate and the method of the application.

The level of calcium ions delivered should be about 0.1 to 1.0 percent by weight based on the weight of the substrate. Preferably the level of calcium will be chosen to deliver about 0.5 percent by weight for dry powder applications to pre-wetted substrates and also about 0.5 percent by weight for aqueous slurry applications. As in the case of the alginate, the level of calcium ions in the adherent coating composition will therefore depend on the substrate and the method of application. Preferably, the calcium ion source will be a food grade water soluble calcium salt. Calcium lactate is particularly preferred.

The level of gum (preferably carrageenan) delivered, based on the weight of the substrate, should be about 0.01 to 0.5 percent by weight. When carrageenan is used, preferably the level will be chosen to deliver about 0.1 percent by weight for dry powder applications to pre-wetted substrates and also about 0.1 percent by weight for aqueous slurry applications. Other gums, such as locust bean gum, xanthan gum, or gum arabic can be used alone or in combination with carrageenan but may produce less adherence.

Finally, the pH of the adherent coating composition preferably will be at least pH 5.5. and most preferably will be in the range of about pH 5.5 to pH 10.0. In the case of the powder, pH may be determined based on a 1% by weight aqueous solution of the dry powder components of the coating composition.

After the adherent coating and particulates are applied, the coated substrate is heat-set. Heat setting coatings refers to heating the coatings until they are no longer tacky, or until they are dry to the touch and adherent to the substrate.

Heating to heat set the coating may be done for example in an oven, by microwaving or by flash frying. When the intended end product is a coated, roasted substrate, the heating to heat set the coating may be performed as part of the roasting of the substrate to produce a final coated roasted substrate.

When the substrate is to be roasted in conjunction with the heat setting process, baking is preferred. The baking will be at a commonly used temperature (e.g., 350° F.) for a period of time sufficient to achieve the desired roasted flavor, color, and texture characteristics in the substrate while at the same time achieving the heat set of the coating. When heat setting without roasting, the time and temperature (or energy density) will be chosen to achieve the desired heat set state. For example, microwaving for about two minutes in a 1000 watt microwave oven has been demonstrated to achieve a good heat set coating on roasted peanuts. Deep frying peanuts in vegetable oil at about 350° F. for about 30 seconds or baking peanuts at about 350° F. for about 5 minutes have likewise achieved good heat set coatings.

The beans, peas and nuts that may be used in the practice of the present invention include unroasted (“green”) as well as roasted almonds, dry beans, brazil nuts, cashews, filberts, peanuts, pecans, peas, pumpkin and squash kernels, sunflower seeds and walnuts. Among these, currently the preferred food substrates are roasted and unroasted peanuts and cashews.

### EXAMPLES

The present invention is illustrated, in part, by the following examples. Further embodiments within the spirit and scope of this invention are described in the specification above and in the claims which follow below.

The invention was examined in a series of tests comparing both slurry and dry applications to a control. In all cases, the coated cashews and green peanuts were spread out on a tray and roasted at 300° F. for about ten minutes (cashews) or 15 minutes (green peanuts) to heat set the coating while roasting the nuts.

The first test involved a slurry application using a coating composition comprising the following ingredients in percentages by weight based on 100 grams of nuts (cashews/green peanuts):

| Ingredients | Percentage by Weight |
|---|---|
| Seasonings | 3.38% |
| Calcium Lactate | 0.25% |
| Carrageenan | 0.05% |
| Sodium Alginate | 0.005% |

Two percent by weight water was added to these dry ingredients to prepare an aqueous slurry. The aqueous slurry was applied to the cashews and the green peanuts in a spray-on application in a tumbler.

A dry application was also tested on cashews and green peanuts using an adherent composition with the following ingredients in percentages by weight based on 100 grams of nuts (cashews/green peanuts):

| Ingredients | Percentage by Weight |
|---|---|
| Seasonings | 3.38% |
| Calcium Lactate | 0.25% |
| Carrageenan | 0.1% |
| Sodium Alginate | 0.05% |

The seasonings referred to above were a combination of vegetable powders, herbs, salt and sugars 80 mesh or less in cross-section.

In this case, the nuts were coated with about 2% by weight water and then the dry ingredients were applied in a tumbler over a period of about one minute (until the nuts were generally evenly coated).

Finally, a control was prepared with a 2% application of a 7% gelatin solution applied in a tumbler. Following the application of the gelatin solution, 3.8% of the above seasoning was applied and peanuts baked at 300° F. for 15 minutes.

In all cases, 100 grams of coated heat set roasted nuts were vigorously shaken in a bag for about one minute to determine the adherence of the coating. Following the shaking, the amount of seasoning that fell off was collected and measured. In the case of the slurry application, there was a 3.26% loss by weight on a seasoning basis and a 0.12% loss by weight on a total seasoned nut basis. In the case of the dry application system, there was a 4.5% by weight loss on a seasoning basis a 0.17% loss on a total seasoned nut basis. This is a very favorable result based on the average adhesion for other adhesive system applications using commonly used levels of adhesives such as the following:

| | % Loss on Total wt |
|---|---|
| Ingredients | Basis After Roasting |
| Gelatin | 0.25–0.45% |
| Modified Corn Starch | 0.3–0.45% |
| Maltodextrin | 0.5–1.0% |
| Xanthan Gum | 0.6–0.75% |
| Tapioca Dextrin | 0.5–0.75% |

While the present invention is described above in connection with preferred or illustrative embodiments, these embodiments are not intended to be exhaustive or limiting of the invention. Rather, the invention is intended to cover all alternatives, modifications and equivalents included within its spirit and scope, as defined by the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A coated food substrate carrying adherent finely divided ingredients comprising:
a food substrate comprising beans, peas or nuts,
a heat set adherent coating on the substrate,
the adherent coating including an alginate salt, a source of calcium ions and a gum; and
finely divided ingredients bound to the substrate by the adherent coating, the finely divided ingredients being under about 10 mesh in cross-section.

2. The coated food substrate of claim 1 in which the substrate is roasted.

3. The coated food substrate of claim 1 in which the alginate salt is sodium alginate.

4. The coated food substrate of claim 1 in which the source of the calcium ions source is a water soluble calcium salt.

5. The coated food substrate of claim 3 in which the water soluble calcium salt is calcium lactate.

6. The coated food substrate of claim 1 in which the gum is carrageenan.

7. The coated food substrate of claim 6 in which the adherent coating includes locust bean gum or xanthan gum in lieu of some or all of the carrageenan.

8. The coated food substrate of claim 1 in which the level of alginate salt is chosen to deliver about 0.001 to 0.1 percent by weight of alginate based on the weight of the substrate.

9. The coated food substrate of claim 1 in which the level of the source of calcium ions is chosen to deliver about 0.1 to 1.0 percent by weight calcium based on the weight of substrate.

10. The coated food substrate of claim 1 in which the level of the source of calcium ions is chosen to deliver about 0.5 percent by weight calcium based on the weight of substrate.

11. The coated food substrate of claim 1 in which the finely divided ingredients are present at a level that will substantially cover the entire exposed coated surface of the substrate.

12. The coated food substrate of claim 1 in which the substrate is chosen from the group consisting of almonds, dry beans, brazil nuts, cashews, filberts, peanuts, pecans, peas, pumpkin and squash kernels, sunflower seeds and walnuts.

13. The coated food substrate of claim 1 in which the finely divided ingredients are powders under about 80 mesh in cross-section.

14. The coated food substrate of claim 1 in which the finely divided ingredients are between about 10 and 80 mesh in cross-section.

15. The coated food substrate of claim 1 in which the finely divided ingredients are between about 30 and 80 mesh in cross-section.

16. A method of preparing a coated food substrate with an adherent layer of finely divided ingredients under about 10 mesh in cross-section comprising:
providing a food substrate in the form of beans, peas or nuts;
applying an adherent coating composition containing an alginate salt, a source of calcium ions, a gum and the finely divided ingredients; and
heat setting the adherent coating.

17. The method of claim 16 in which the beans, peas or nuts are roasted while heat setting the adherent coating.

18. The method of claim 16 in which the alginate salt is sodium alginate and the source of calcium ions is calcium lactate.

19. The method of claim 16 in which the coated substrate is heat set by a step chosen from the group consisting of baking in an oven, microwaving, and flash frying.

20. The method of claim 16 in which the substrate is chosen from the group consisting of almonds, dry beans, brazil nuts, cashews, filberts, peanuts, pecans, peas, pumpkin and squash kernels, sunflower seeds and walnuts.

21. The method of claim 16 in which the finely divided ingredients are applied to the substrate by dispersing the particulates in the adherent composition, forming an aqueous slurry and then applying the adherent composition to the substrate as an aqueous slurry.

22. The method of claim 16 in which the finely divided ingredients and the adherent coating composition are combined in a dry mixture, the substrate is wetted with water, and the dry mixture is applied to the wetted substrate.

23. The method of claim 16 in which multiple adherent layers are applied.

24. The method of claim 16 in which the pH of the adherent coating composition is at least 5.5.

25. The method of claim 16 in which the pH of the adherent coating composition is about 5.5 to 10.0.

26. The method of claim 16 in which, the level of alginate salt is chosen to deliver about 0.001 to 0.1 percent by weight of alginate based on the weight of the substrate and the level of the source of calcium ions is chosen to deliver about 0.1 to 1.0 percent by weight calcium based on the weight of substrate.

27. The method of claim 16 in which the gum is carrageenan.
